(19) United States
(12) Patent Application Publication
(10) Pub. No.: US 2012/0116576 A1
(43) Pub. Date: May 10, 2012

(54) VENDING MACHINE STIR-STICK AND SUGAR DISPENSING ASSEMBLY

(76) Inventors: Claudio Mosconi, Bergamo (IT); Sergio Pesenti Barili, Stezzano (IT); Silvano Personeni, Mazzoleni (IT)

(21) Appl. No.: 13/063,566

(22) PCT Filed: Sep. 11, 2009
(86) PCT No.: PCT/EP2009/061819

§ 371 Date: Oct. 28, 2011

(30) Foreign Application Priority Data
Sep. 12, 2008 (IT) TO2008A000673

(51) Int. Cl. G06F 17/00

(52) U.S. Cl. 700/232

(57) ABSTRACT

An assembly for dispensing stir-sticks and sugar in a beverage vending machine, the assembly having a fixed storage device defined by two stores, each for housing a respective stack of stir-sticks; an extracting device associated with the storage device and having, for each store, a respective extractor associated with the relative store and for extracting individual stir-sticks from the relative store; a sugar dispensing device; and an actuating device common to the two extractors, and which operates either one of the extractors at each operating cycle.

### CROSS-REFERENCE TO RELATED APPLICATIONS

This application is a U.S. Nationalization of PCT International Application No. PCT/EP2009/061819 filed 11 Sep. 2009, which claims priority to Italian Patent Application No. TO2008A000673 filed 12 Sep. 2008, the entireties of both of the foregoing applications are incorporated herein by reference.

### TECHNICAL FIELD

The present invention relates to a vending machine stir-stick and sugar dispensing assembly.

### BACKGROUND ART

In known vending machines, the stir-sticks are normally housed, as disclosed, for example, in EP-A-1586254, in a store defined by a vertical tubular body housing a stack of stir-sticks, from which a dispensing device withdraws the bottom stir-stick one at a time.

Since the height of the stack determines how long the machine can operate between refills, at least as regards the stir-stick store, and since the stack cannot exceed a given height, it has been proposed, to prolong operation of the machine between refills, to arrange the stir-sticks in a number of stacks movable selectively into the withdraw station. This solution, however, which is known, for example, from EP1107200, seriously complicates the design, and so increases the cost and impairs the reliability, of the machine.

### SUMMARY

One or more of the embodiments of the present invention provide a vending machine stir-stick and sugar dispensing assembly designed to eliminate the above drawbacks.

According to an embodiment of the present invention, there is provided a vending machine stir-stick and sugar dispensing assembly. In the assembly as defined above, the actuating device is reversible, and comprises a drive shaft rotating about a respective axis; and transmission means integral with the drive shaft, and which, at each operating cycle, selectively operate the extractors, and possibly also operate sugar dispensing means, prior to selectively operating the extractors.

The assembly referred to above also provides a simple, low-cost solution to a further, sugar dispensing, problem often encountered in known vending machines, such as the machine described in EP 1 586 254 A1.

That is, besides being structurally complicated, known machines of this type have the drawback of dispensing the stir-stick and sugar substantially simultaneously into a cup containing the beverage. As a result, at least part of the sugar poured into the cup drops onto the stir-stick, thus resulting in the fine component of the sugar rising and settling on the surfaces and any component parts of the machine in the cup-fill area. Part of the sugar poured into the cup may even be deflected by the stir-stick and fall outside the cup.

### BRIEF DESCRIPTION OF THE DRAWINGS

A non-limiting embodiment of the invention will be described by way of example with reference to the accompanying drawings, in which:

FIGS. 1 and 2 show views in perspective, from different angles and with parts removed for clarity, of a preferred embodiment of the assembly according to the present invention;

FIGS. 3 and 4 show respective larger-scale details, with parts removed for clarity, of the FIG. 1 assembly;

FIG. 5 shows a cross section of a detail of the FIG. 1 assembly;

FIG. 6 shows a larger-scale side view of a detail in FIG. 5;

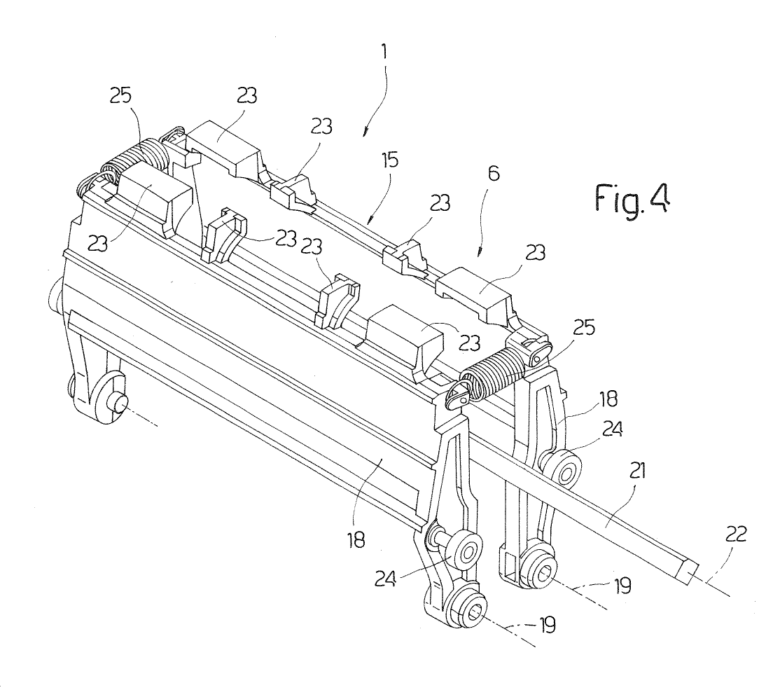

FIGS. 7A-7D show the FIG. 5 detail in respective operating configurations;

FIGS. 8A-8D show the FIG. 6 detail in respective operating configurations;

FIGS. 9A-9C show a detail of FIG. 3 in respective operating configurations;

FIGS. 10 and 11 show a preferred embodiment of a detail in FIGS. 1 and 3 in respective operating configurations.

### DETAILED DESCRIPTION

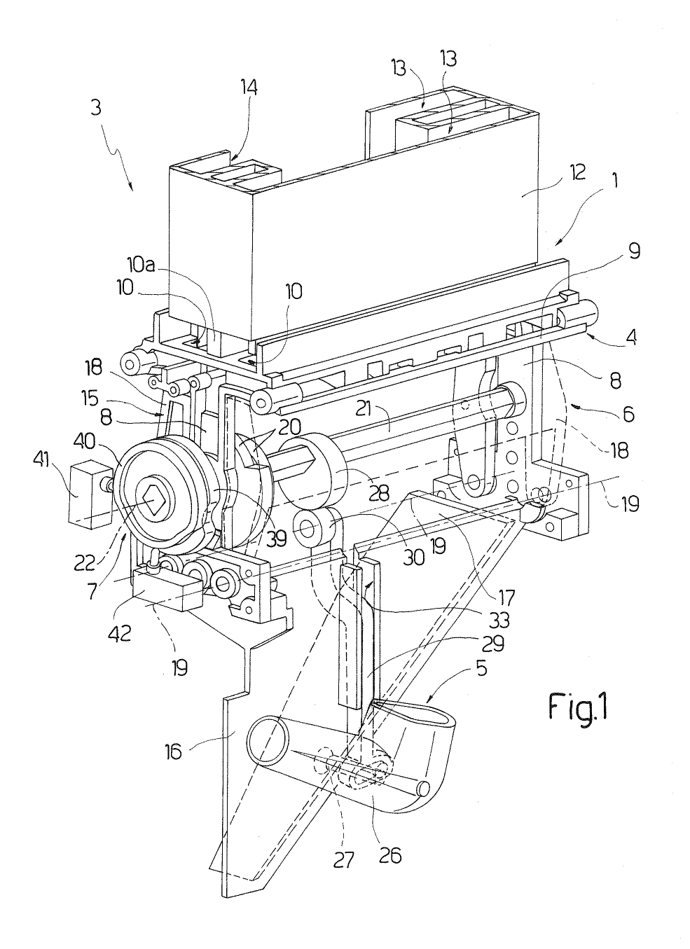

Number 1 in FIGS. 1 and 2 indicates as a whole an assembly for dispensing known stir-sticks 2 and measured quantities of sugar in a vending machine 3.

Assembly 1 comprises a frame 4, and a dispenser unit mounted on frame 4 and in turn comprising a sugar dispenser 5, a dispenser 6 for dispensing stir-sticks 2, and an actuating device 7 for operating both dispenser 5 and dispenser 6.

Frame 4 has a gantry structure defined by two parallel, substantially vertical, lateral uprights 8, and by a top cross member 9, which connects lateral uprights 8 and is defined by a substantially horizontal plate having two rectangular openings 10 separated by a central partition 10a perpendicular to uprights 8. As shown in FIG. 2, each opening 10 is larger across and in length than a stir-stick 2, and is partly bounded transversely by three respective appendixes 11, which are bounded at the top by respective flat, substantially horizontal surfaces, and extend from an outer edge of relative opening 10 towards central partition 10a, so as to each define, with central partition 10a, a respective passage for a stir-stick 2.

Dispenser 6 comprises a store 12, which is defined by a hollow body extending vertically inside machine 3 and internally defining two side-by-side stores or channels 13, each of which houses a respective stack of stir-sticks 2 and has a bottom outlet facing a corresponding opening 10 in top cross member 9. The two channels 13 are separated partly by a partition located over central partition 10a and divided into two parts by a central passage; and an outer wall of one of the two channels 13 has a longitudinal opening 14 accessible by an operator to load stir-sticks 2 firstly into the adjacent channel 13 through opening 14 and said central passage, and then into the channel 13 communicating with opening 14.

In a different embodiment not shown, both channels 13 have a longitudinal fill opening similar to opening 14 described above.

Just below store 12, dispenser 6 comprises an extracting device 15 for extracting stir-sticks 2 one by one from store 12 and feeding the extracted stir-stick 2 into a cup (not shown) positioned beforehand in a fill station (not shown). The extracted stir-stick 2 is guided to the fill station by a chute fitted to frame 4 and comprising a vertical wall 16, and a sloping surface 17, which is square with respect to vertical wall 16, is integral with vertical wall 16, extends downwards from one of lateral uprights 8 to the other lateral upright 8, and is positioned facing openings 10 in top cross member 9.

In a further embodiment not shown, sloping surface 17 is fitted removably and adjustably to wall 16, so it can be set to different tilt angles, at the assembly stage, depending on the space available in the machine 3 to which it is fitted.

As shown in FIGS. 1, 3 and 4, extracting device 15 comprises, for each channel 13, an extractor 18 fitted to lateral uprights 8 and interposed between top cross member 9 and sloping surface 17 to oscillate, under the control of actuating device 7, about a respective fixed, substantially horizontal axis 19 crosswise to lateral uprights 8 and parallel to central partition 10a. In short, the two extractors 18 are positioned specularly with respect to a vertical central plane through a longitudinal axis of central partition 10a.

In actual use, extractors 18 are operated by actuating device 7 via a cam transmission comprising, for each extractor 18, a cam 20 angularly integral with a drive shaft 21, which is supported in rotary manner by lateral uprights 8, beneath central partition 10a, and is rotated about its axis 22, parallel to central partition 10a, by a known reversible motor (not shown) to oscillate to and from a start position at each operating cycle of machine 3, and to oscillate either one of extractors 18 about relative axis 19.

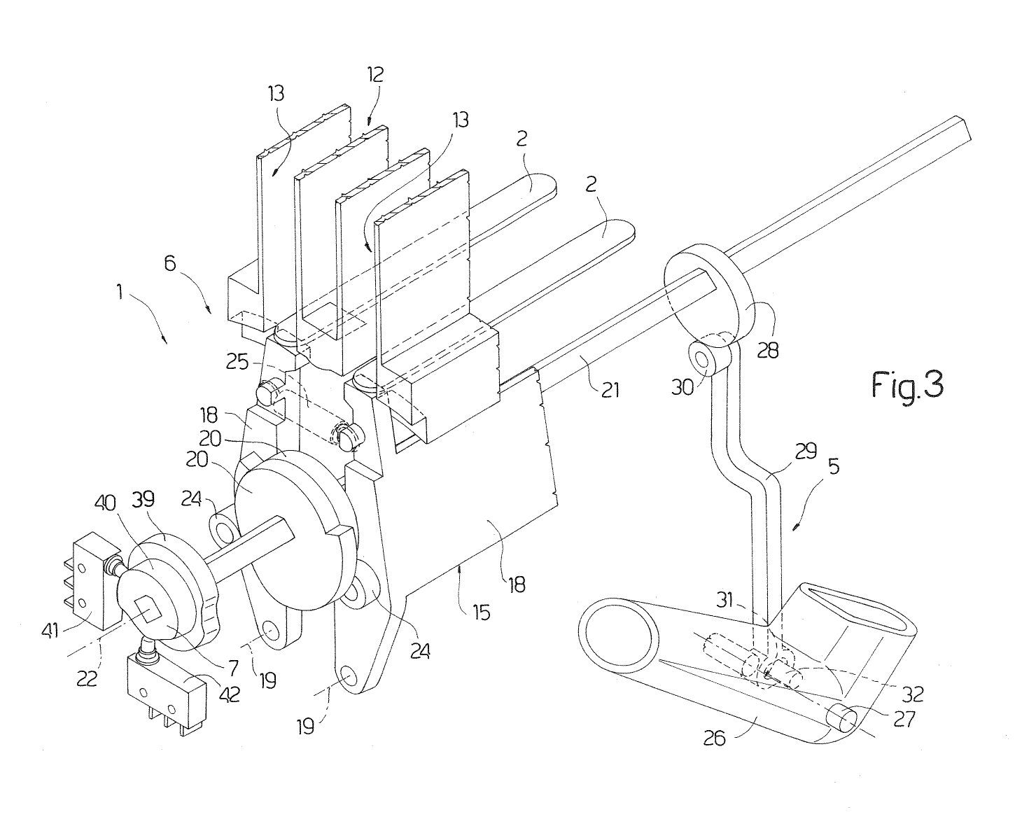

More specifically, each extractor 18 is defined by a paddle, which is positioned facing the other extractor 18, is hinged at the bottom about relative axis 19, and has, along its top edge, four teeth 23 which, when relative extractor 18 is in a rest position (FIG. 2), are positioned facing the outlet of corresponding channel 13, and alternate with appendixes 11 of corresponding opening 10. As shown clearly in FIG. 5, teeth 23 of each extractor 18 are bounded at the top by respective flat surfaces which, in said rest position, are located at a higher level than the flat surfaces of corresponding appendixes 11, and define a supporting surface for the stack of stir-sticks 2 in corresponding channel 13. More specifically, teeth 23 are higher than appendixes 11 by an amount substantially equal to the thickness of a stir-stick 2.

The number of appendixes 11 and teeth 23 in the example shown in the attached drawings is purely by way of example, and, in other embodiments, may be more or less, without in any way affecting the operation of dispenser 6.

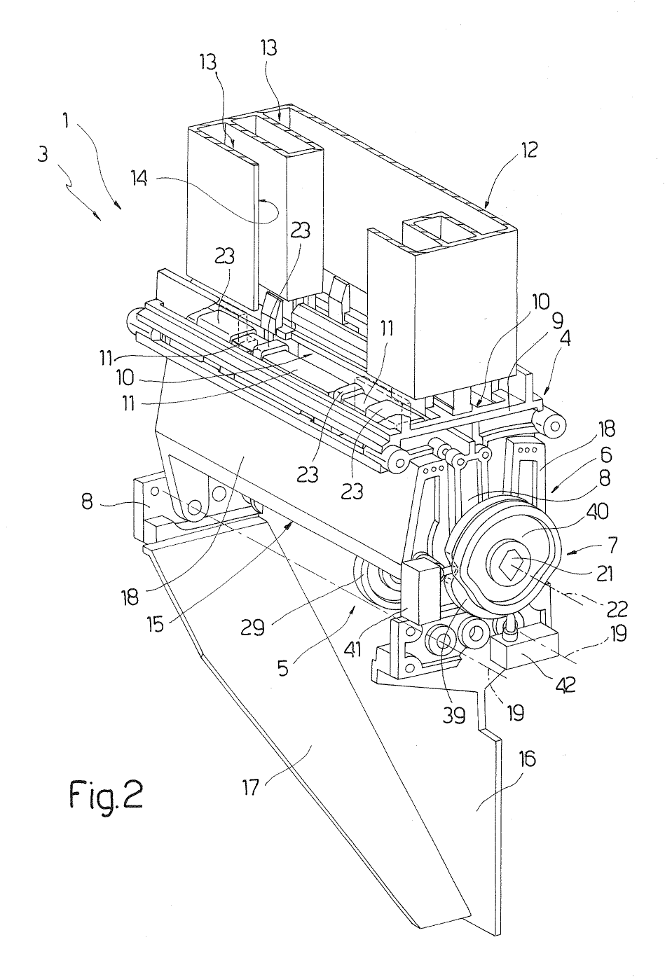

On an end surface facing one of lateral uprights 8, each extractor 18 is fitted integrally with a pin which is parallel to axis 22, is interposed between axis 22 and oscillation axis 19 of relative extractor 18, and defines a cam follower 24 cooperating with cam 20 associated with extractor 18. As shown in FIGS. 3 and 5, cams 20 are defined by respective disks, which are fitted, superimposed side by side, to shaft 21 close to a lateral upright 8, and each have a track extending about axis 22 and comprising a circular portion A coaxial with axis 22, and a portion B eccentric with respect to axis 22.

Cams 20 have identical profiles, but are fitted to shaft 21 upside down with respect to each other, so that, in use, as described in detail below, one of the two cam followers 24 travels along relative circular portion A without moving relative extractor 18, while the other cam follower 24 travels along relative portion B to oscillate relative extractor 18 to and from its rest position and so extract a stir-stick 2. The active selector 18 is selected by the rotation direction of shaft 21.

Each extractor 18 is held in the normal rest position (FIGS. 3 and 4) by two coil springs 25, each of which is located at a longitudinal end of extractors 18, above axis 22, and extends from one extractor 18 to the other in a direction crosswise to axis 22.

With reference to FIGS. 1, 3, 10 and 11, sugar dispenser 5 comprises a funnel 26 located on the opposite side of vertical wall 16 to sloping surface 17, and connected to a known store (not shown) by a known feed conduit (not shown) to receive a measured quantity of sugar whenever sugar is requested by the user when selecting the beverage.

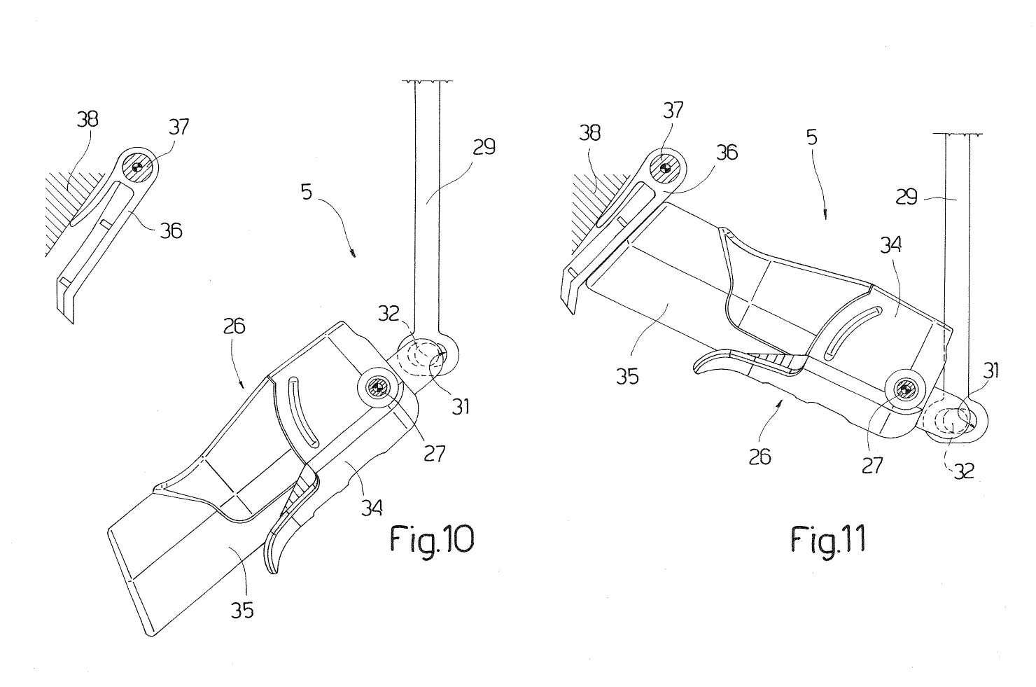

Funnel 26 is fitted in rotary manner to vertical wall 16, by a horizontal pin 27 crosswise to axis 22, to oscillate, under the control of actuating device 7, between a containment position (FIGS. 1, 3, 11), in which the outlet of funnel 26 faces upwards to hold the sugar loaded into it, and a dispensing position (FIG. 10), in which the outlet of funnel 16 faces downwards towards the cup (not shown) to dispense the sugar directly into the cup.

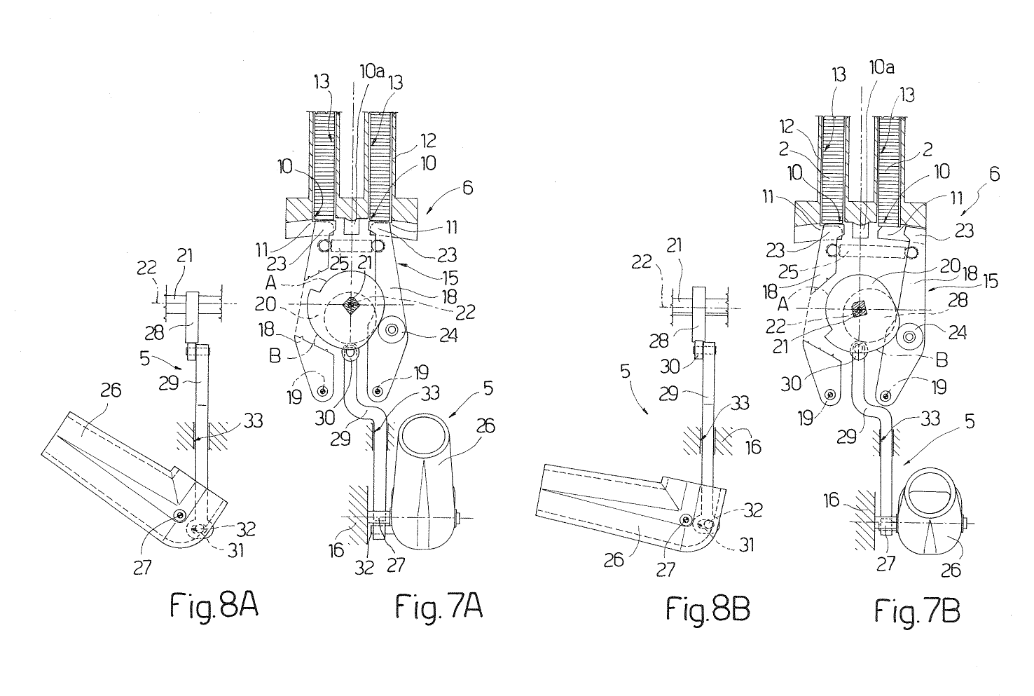

Funnel 26 is operated by actuating device 7 by means of a cam system comprising a cam 28 defined by a circular disk fitted eccentrically to shaft 21, between lateral uprights 8; and an actuating arm 29, the top end of which has a cam follower 30 cooperating with cam 28, and the bottom end of which has a slot 31 engaged in sliding and rotary manner by a pin 32 crosswise to axis 22 and connected rigidly to funnel 26 on the opposite side of the outlet to pin 27. With particular reference to FIGS. 1, 8A and 8C, part of arm 29 is fitted through a slit 33 in vertical wall 16, so arm 29, in use, is forced to move, parallel to itself and in a direction crosswise to axis 22, between a normal lowered position, in which cam follower 30 is positioned a maximum distance from axis 22, and funnel 26 is maintained in the containment position; and a raised work position, in which cam follower 30 is positioned a minimum distance from axis 22, and funnel 26 is in the dispensing position. A spring (not shown) between cam follower 30 and cam 28 serves to hold cam follower 30, in use, in contact with cam 28 at all times.

In the preferred embodiment shown in FIGS. 10 and 11, funnel 26 comprises a mounting portion 34 integral with pin 27; and an end portion 35, which is open at the top to load the sugar, and is removable from portion 34 to clean funnel 26. When funnel 26 is in the containment position (FIG. 11), the outlet of end portion 35 is closed by a stopper 36, which is fitted in oscillating manner to a pin 37 parallel to pin 27 and integral with a fixed wall 38 connected rigidly to wall 16. Stopper 36 is movable on wall 38 between a normal rest position (FIG. 10), in which funnel 26 is in the dispensing position, and stopper 36 is kept detached from wall 38 by an elastic member located between stopper 36 and wall 38; and a work position (FIG. 11), in which funnel 26 is in the containment position and presses stopper 36 against wall 38, so the outlet of end portion 35 is fully closed by stopper 36. In addition to closure, stopper 36 also serves to scrape the outlet of funnel 26, as this moves back into the containment position, to remove any sugar residue.

As stated, sugar is only dispensed during the operating cycle if, in addition to routine supply of stir-stick 2, user selection also calls for a given measure of sugar. Selective operation of sugar dispenser 5 is achieved by varying the degree of oscillation of shaft 21, so that only stir-stick 2 is dispensed if a beverage with no sugar is selected, and a given measure of sugar and a stir-stick 2 are dispensed, the sugar before stir-stick 2, if a sugared beverage is selected.

Accordingly, actuating device 7 comprises a control unit, operation of which is described in detail below, and which comprises a central control unit (not shown) connected to a known external selection panel (not shown) of machine 3; and detecting means for determining the angular position of shaft 21, and which comprise two cams 39, 40 fitted to shaft 21, and two microswitches 41, 42 associated with respective cams 39, 40 and connected to the central control unit (not shown).

The control unit also serves to govern selective extraction of stir-sticks 2 from relative channels 13. This is done by the central control unit (not shown) oscillating shaft 21 in opposite directions at alternate operating cycles, so stir-sticks 2 are extracted alternately from the two channels 13, or oscillating shaft 21 in the same direction at each operating cycle, so stir-sticks 2 are extracted from the same channel 13, and only inverting the oscillation direction of shaft 21 when channel 13 is empty. Accordingly, the control unit comprises at least one known optical or electromechanical sensor (not shown) which, in use, supplies the central control unit (not shown) with a signal indicating the presence or absence of stir-sticks 2 in channels 13.

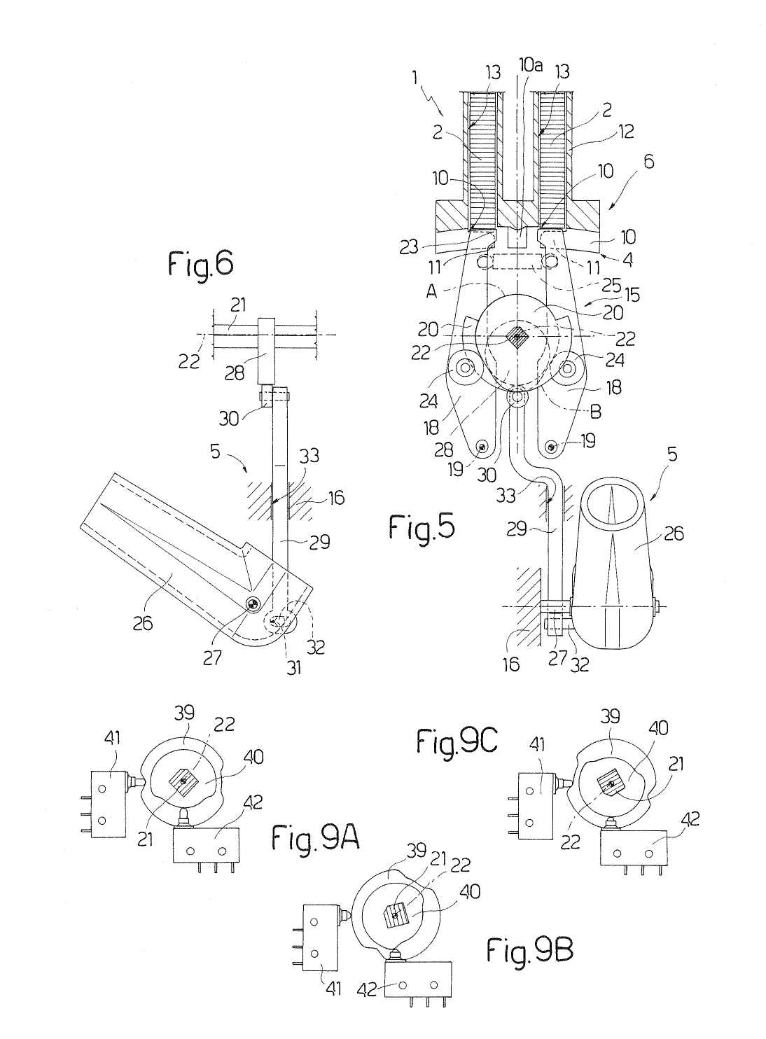

Operation of the assembly will now be described as of the operating position shown in FIGS. 7A, 8A and 9A, in which extractors 18 are in their respective rest positions, funnel 26 is in the containment position, and microswitches 41, 42 are both open.

In the case described below, the central control unit (not shown) is assumed programmed to extract stir-sticks 2 from the right-side channel 13 in FIG. 7A, which, for the sake of clarity, only shows cam 20 for operating extractor 18 of the channel 13 considered.

It is also assumed that user selection calls for no sugar, so no sugar is supplied to funnel 26, which at most contains sugar residue from a previous sugar dispensing operation.

Once selection is made on the external panel (not shown), the motor (not shown) is operated by the central control unit (not shown) to rotate shaft 21, and therefore cam 20, anticlockwise, so cam follower 24 begins travelling along relative portion B to rotate extractor 18 clockwise about relative axis 19.

Start of the operating cycle is signalled to the central control unit (not shown) by rotation of cam 39 closing microswitch 41.

As teeth 23 of extractor 18 are withdrawn from the outlet of relative channel 13, the stack of stir-sticks 2 formerly resting on teeth 23 drop by gravity onto appendixes 11 of relative opening 10.

At the same time, rotation of cam 28 raises arm 29 and so swings funnel 26 downwards.

By the time shaft 21 has rotated roughly 60 degrees (FIGS. 7B and 8B), extractor 18 is set to the maximum angular position with respect to the rest position, and funnel 26 is set to a slightly lowered position with respect to the containment position, but still raised enough to prevent fall-out of any sugar residue.

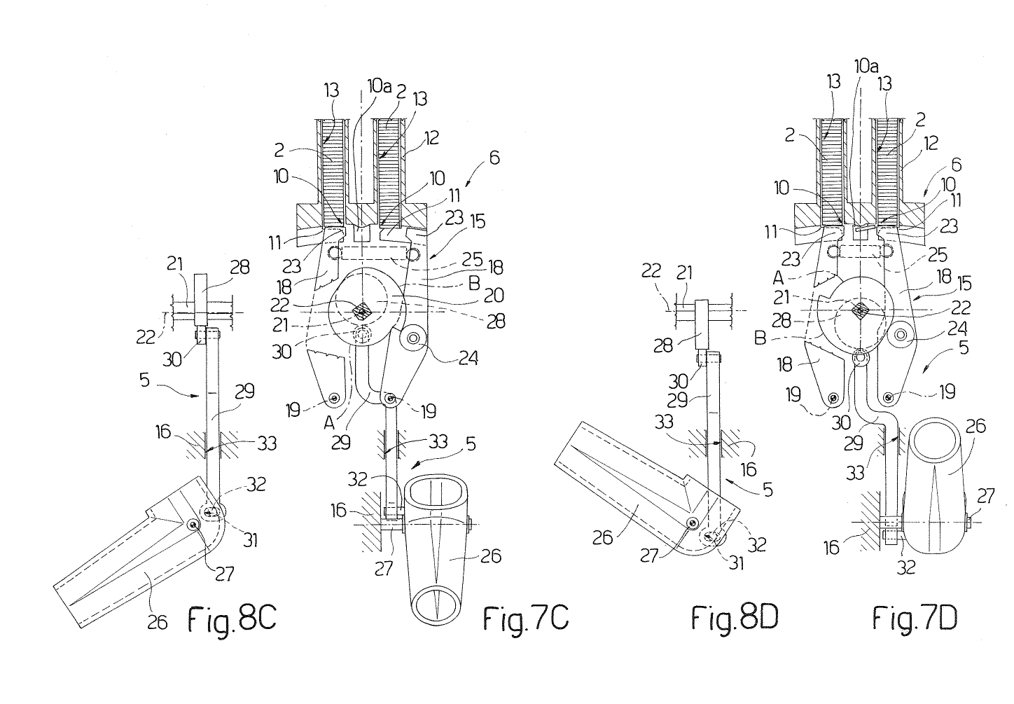

Reaching the above angular position is signalled to the central control unit (not shown) by microswitch 42 associated with cam 40 closing (FIG. 9B).

At this point, rotation of shaft 21 is inverted, and extractor 18 is restored by return springs 25 to the rest position (FIGS. 7D and 8D). Over the last part of this movement, teeth 23 are inserted comb-fashion between appendixes 11 to push the bottom stir-stick 2 in the stack towards central partition 10a, so the stir-stick 2 drops by gravity through relative opening 10.

At the same time, clockwise rotation of cam 28 restores funnel 26 to the containment position.

In the event user selection calls for the addition of sugar, rotation of shaft 21, as opposed to being inverted after 60 degrees, is continued up to roughly 165 degrees (FIGS. 7C, 8C and 9C); and reaching this angular position is signalled to the central control unit (not shown) by microswitch 41 associated with cam 39 opening (FIG. 9C). During anticlockwise rotation between 60 and 165 degrees, cam follower 24 travels along a circular portion of portion B to keep extractor 18 in the position reached after 60 degrees rotation; whereas rotation of cam 28 moves cam follower 30 towards axis 22, thus raising arm 29 and moving funnel 26 into the dispensing position to unload the measure of sugar fed beforehand into funnel 26 by a known feed device (not shown) following user selection at the start of the operating cycle. In a different operating mode, as opposed to being loaded beforehand into funnel 26, the sugar is not loaded into funnel 26 until this reaches the dispensing position.

After a given time lapse, rotation of shaft 21 is inverted to raise funnel 26 and, as described above, expel a stir-stick 2 by restoring extractor 18 to the rest position.

It is important to note that, in both the above cases, throughout the operating cycle, cam follower 24 associated with the idle extractor 18 travels along portion A of relative cam 20, and imparts no movement to respective extractor 18 (in this case, the left-hand extractor in FIG. 5), which remains throughout in the rest position.

In short, therefore, actuating device 7:
provides for dispensing stir-sticks and sugar using only one motor;
is designed so that operation of the selected extractor 18 automatically disables operation of the other extractor 18;
is designed to impart to relative cams 20 and 28 oscillations comprising a forward rotation and a return rotation, which may vary in degree, depending on whether sugar is to be dispensed or not;
is designed so that sugar, if selected, is dispensed during forward rotation, and the stir-stick is dispensed at the end of the return rotation.

In short, assembly 1 provides for dispensing stir-stick 2 after the sugar, thus preventing the sugar from being poured at least partly onto stir-stick 2, as would be the case if the two steps were inverted, and so preventing the fine part of the sugar from rising and fouling the surfaces in the fill station area.

1) An assembly for dispensing sugar and stir-sticks in a beverage vending machine, the assembly comprising;
storage means for the stir-sticks;
extracting means associated with the storage means and for extracting individual ones of the stir-sticks from the storage means;
sugar dispensing means;
wherein the storage means are fixed storage means and comprise two stores, each designed to house a respective stack of the stir-sticks;
wherein the extracting means comprise, for each store, a respective extractor associated with, and for extracting individual ones of the stir-sticks from, the respective store;
a programmable actuating device, which is common to the extractors, is reversible, and comprises a drive shaft having an axis and mounted for rotation thereabout;
wherein the programmable actuating device is designed to make the drive shaft oscillate about the axis and perform, at each operating cycle and starting from a start position, an oscillation comprising a forward rotation in a programmable direction, and a return rotation;
wherein the programmable actuating device further comprises transmission means connected to the drive shaft to selectively operate, at each operating cycle, during the return rotation, either one of the respective extractors, depending on the rotation direction of the drive shaft during the forward rotation, and also to operate the sugar dispensing means, if required, before operating either one of the two extractors; and
wherein the operation of the sugar dispensing means is dependent on the degree of the oscillation, and independent of the rotation direction of the drive shaft during the forward rotation.

2) The assembly as claimed in claim 1, wherein the transmission means comprise first cam means mechanically connecting the drive shaft to the extractors.

3) The assembly as claimed in claim 2, wherein the first cam means comprise, for each extractor, a cam angularly integral with the drive shaft and connected to the relative extractor to move the extractor along a path extending to and from a rest position, which is both an extraction position to extract one stir-stick from the bottom of the stack in the relative store, and a support position to support the rest of the same stack.

4) The assembly as claimed in claim 3, further comprising a frame having, underneath each store, a respective opening with transverse extensions, which face a bottom outlet of the relative store to define a first supporting surface for the relative stack, and limit the size of the opening to define, within the opening, a passage for the stir-sticks in the stack; each extractor having pushers which move, substantially parallel to the extensions, with the extractor, and define, when the relative extractor is in the rest position, a second supporting surface for the relative stack; the second supporting surface being higher than the first supporting surface.

5) The assembly as claimed in claim 3, wherein each cam of the first cam means has a control profile extending about the axis and comprising a first portion coaxial with the axis, and a second portion which is at least partly eccentric with respect to the axis; the cams being angularly out of phase with respect to each other about the axis, so that, during any operating cycle and depending on the oscillation direction of the drive shaft, one of the extractors moves along the relative first portion and remains motionless in a rest position thereof, while the other extractor moves along the relative second portion to move along the path.

6) The assembly as claimed in claim 5, wherein the second portion comprises a first part coaxial with the axis; and a second part eccentric with respect to the axis and extending between the first portion and the first part.

7) The assembly as claimed in claim 5, wherein the extractors are mounted on opposite sides of the axis to oscillate about respective oscillation axes substantially parallel to the axis; the two cams having identical control profiles, and being fitted to the drive shaft upside down with respect to each other.

8) The assembly as claimed in claim 1, wherein the transmission means comprise second cam means mechanically connecting the drive shaft to the sugar dispensing means.

9) The assembly as claimed in claim 1, wherein first-degree oscillations of the drive shaft only operate one of the extractors and extract one stir-stick; while second-degree oscillations, greater than the first-degree oscillations, of the drive shaft operate one of the extractors and also the sugar dispensing means.

10) An assembly for dispensing sugar and stir-sticks in a beverage vending machine, the assembly comprising;
a fixed storage device including two stores, each of the two stores configured to house a respective stack of the stir-sticks;
an extracting device associated with the fixed storage device and configured to extract individual ones of the stir-sticks from the fixed storage device, the extracting device including, for each of the two stores, a respective extractor associated with, and for extracting individual ones of the stir-sticks from, a corresponding one of the two stores;
a sugar dispensing device;
a reversible programmable actuating device, which is common to the extractors, the reversible programmable actuating device comprises a drive shaft having an axis and mounted for rotation thereabout;
wherein the reversible programmable actuating device is configured to make the drive shaft oscillate about the axis and perform, at each operating cycle and starting from a start position, an oscillation comprising a forward rotation in a programmable direction, and a return rotation;
wherein the programmable actuating device further comprises a transmission device connected to the drive shaft to selectively operate, at each operating cycle, during the return rotation, either one of the respective extractors, depending on the rotation direction of the drive shaft during the forward rotation, and also to operate the sugar dispensing device, if required, before operating either one of the two extractors; and
wherein the operation of the sugar dispensing device is dependent on the degree of the oscillation, and independent of the rotation direction of the drive shaft during the forward rotation.
